(19) United States
(12) Patent Application Publication
(10) Pub. No.: US 2025/0178454 A1
(43) Pub. Date: Jun. 5, 2025

(54) Longitudinal Deceleration During a Creeping Operation for Motor Vehicles With Two Electrically Drivable Axles

(71) Applicant: Bayerische Motoren Werke Aktiengesellschaft, Muenchen (DE)

(72) Inventors: Werner FOAG, Muenchen (DE); Jonas LANG, Muenchen (DE)

(21) Appl. No.: 18/844,158

(22) PCT Filed: Mar. 21, 2023
(86) PCT No.: PCT/EP2023/057163

§ 371 Date: Sep. 5, 2024

(30) Foreign Application Priority Data
Apr. 20, 2022 (DE) 10-2022 109 483.9

(51) Int. Cl. B60L 15/20

(52) U.S. Cl. CPC B60L 15/2063; B60L 2240/423

(57) ABSTRACT

The present disclosure relates to a drive assembly of a motor vehicle with a first driven axle which is paired with a first electric drive machine, a second driven axle which is paired with a second electric drive machine, and a control unit which is designed to control a method having the following steps: identifying a deceleration request for the motor vehicle; and actuating a specified drive distribution process to the two axles, wherein the first drive machine and the second drive machine are operated with identical axle torque balances when the drive distribution process is actuated.

### BACKGROUND AND SUMMARY

The present disclosure relates to a method for operating a motor vehicle with two driven axles, and also to a drive arrangement with a control unit for carrying out such a method.

In the case of motor vehicles with propulsion by internal-combustion engine and with a converter automatic transmission or with a transmission with modeled response, the fine metering of the speed below a crawling speed of about 7 km/h is effected by bracing of drivetrain and brake.

For electric drives, this response has been adopted in known vehicles. In a driving mode that has been modeled on a driving response of an internal-combustion engine (in previous vehicles developed by the applicant, driving mode D), crawling occurs without pedal actuation, as in the case of a converter transmission; in the case of actuation of the brake pedal, stopping is effected by means of friction brake until the vehicle is brought to a standstill.

By virtue of the distribution of force, manifested in opposing manner, of drive and brake to the axles (as a rule, more braking force at the front than at the rear, more propulsive force at the rear than at the front), the chassis and the body are integrated into the bracing as a force path. As a rule, the surplus of braking force for stopping arises on the front axle at first and on the rear axle shortly after. This results in a slight jolt when attempting to stop comfortably.

Against this background, it is an object of the invention to improve a soft stop—that is to say, low-jolt stopping—in the case of motor vehicles with two electrically drivable axles.

Each of the independent claims determines with its features a subject that achieves this object. The dependent claims relate to advantageous developments of the invention.

According to one aspect, a method is disclosed for operating a motor vehicle with a first driven (in particular, front) axle, to which a first electric prime mover and, in particular, a first vehicle brake have been assigned, and with a second driven (in particular, rear) axle, to which a second electric prime mover and, in particular, a second vehicle brake have been assigned, in a crawling mode.

The method may feature the following steps, which may be carried out in the specified sequence or in another sequence appropriate to the art:
(o) According to one embodiment, determining and/or detecting a crawling mode of the motor vehicle. In the case of determining the crawling mode, this mode is switched, in particular manually. In the case of detecting the crawling mode, this mode is suggested automatically or switched automatically, in particular as a function of operating conditions.
(i) Identifying a desire of the driver for deceleration as regards a longitudinal guidance of the motor vehicle. The driver can express the desire for deceleration by means of, for instance, a depression of the brake pedal.
(ii) After determining or detecting the crawling mode and/or after identifying the desire for deceleration, in particular in response thereto: triggering a predetermined drive distribution to the two axles, the first prime mover and the second prime mover being operated with identical axle-torque balances of acceleration torques and deceleration torques with the triggered drive distribution.

In this case, an acceleration torque is, in particular, a drive torque applied by means of the electric prime mover, which aims to achieve a longitudinal acceleration of the vehicle (irrespective of whether a longitudinal acceleration also occurs by reason of other influencing variables acting). In this case, a deceleration torque is, in particular, a braking torque applied by means of the wheel brakes, which aims to achieve a longitudinal deceleration of the vehicle (irrespective of whether a longitudinal deceleration also occurs by reason of other influencing variables acting).

This means, in particular, that there is an axle-torque-balance discrepancy delta_MB between the two axles amounting to 0 Nm—in other words, there is no axle-torque-balance discrepancy between the two axles.

Consequently, acceleration torques and equal-magnitude deceleration torques do not have to be applied to the front axle; only the balance of the acceleration torques and the deceleration torques relative to one another has to be the same on both axles.

By virtue of a distribution of propulsive force that has been optimized in such a manner in the crawling mode, the bracing of the chassis occurs only locally on the axles and no longer across the entire chassis and body.

According to one embodiment, the method additionally features at least the following steps: (iii) identifying a desire to stop as a desire for deceleration in respect of the motor vehicle, and subsequently (iv) triggering the predetermined drive ratio, at least until the vehicle has come to a standstill, in particular on both axles simultaneously.

If deceleration is effected in this way to a longitudinal speed of zero, a jump in the coefficient of friction—from sliding friction to static friction—takes place on both axles simultaneously. As a result—unlike in the case of conventional stopping—no bracing across the body occurs any longer. The time of stopping has therefore been clearly defined, combined with an avoidance of two-phase entry into static friction.

This holds true at least when the kinetic energy, which is very low, particularly in the case of a soft stop, is disregarded, typically at a speed of less than 0.1 m/s, but in less pronounced manner also in the case of a crawling mode at speeds below 2 m/s, for instance.

“Standstill” here means, in particular, that the tires of a drive axle have entered into static friction with the subsurface of the vehicle.

In this case, the crawling mode is determined, in particular, by a low positive or negative longitudinal speed (below an absolute value of 2 m/s, for instance) and/or by a low positive or negative longitudinal acceleration (=change in longitudinal speed) of the vehicle (below an absolute value of about 0.1 g≈1 m/s²), for instance, and relates to a fine-metering operating range close to standstill as regards the control elements for longitudinal speed (in other words, in particular, the pedals) of the motor vehicle.

According to a further aspect, a drive arrangement is disclosed of a motor vehicle with a first driven axle, to which a first electric prime mover has been assigned, and with a second driven axle, to which a second electric prime mover has been assigned, and with a control unit which has been configured to trigger a method according to one of the preceding claims.

According to one embodiment, in the described crawling mode the drive distribution provides a greater part of a drive torque applied to both axles overall on the front axle. This makes possible an identical axle-torque balance on both axles, particularly in combination with a braking distribution that places greater emphasis on the front axle than on the rear axle.

According to one embodiment, the drive distribution is predetermined as a function of an absolute deceleration that is required for the purpose of putting the identified desire for deceleration into effect. Therefore a deceleration without bracing of the axles against one another (for example, via the chassis or a support structure of the vehicle) can be made possible in each instance for a wide deceleration range (=range of absolute deceleration values) in the crawling mode.

According to one embodiment, differing drive distributions are predetermined for differing required absolute decelerations. Therefore a deceleration without bracing of the axles against one another (for example, via the chassis or a support structure of the vehicle) can be made possible in each instance for a wide deceleration range (=range of absolute deceleration values) in the crawling mode.

According to one embodiment, differing axle-torque balances, identical on both axles, are triggered for differing required absolute decelerations, the same axle-torque balance always being triggered on both axles for a required absolute deceleration. Therefore, differing decelerations (at least between the axles) can be put into effect without bracing.

According to one embodiment, a maximally achievable deceleration is determined by an extreme drive distribution, in particular wholly to the first electric prime mover, particularly in the case of static braking-torque characteristics on both axles. Therefore, the deceleration range that is achievable with the invention can be maximized.

According to one embodiment, in the course of putting an identified desire for deceleration into effect outside of a crawling mode firstly a classical deceleration mode with a relatively higher deceleration torque on the front axle and with a relatively higher acceleration torque on the rear axle is triggered, and the predetermined drive distribution is triggered in the course of the crawling mode or after entering it.

Therefore, in operating states outside of the crawling mode the dynamics of retardation (with the greater relevance of front braking) can also be taken into account when applying the invention.

According to one embodiment, after a standstill a requisite standstill deceleration torque is applied equally by both prime movers, particularly in case there is a sufficient reserve of braking torque on both axles. As a result, a renewed start-up is facilitated. The motor vehicle can, in particular, start up again more quickly and/or with minimal expenditure of energy.

### BRIEF DESCRIPTION OF THE DRAWINGS

Further advantages and possible applications of the invention will become apparent from the following description in conjunction with the Figures:

FIG. 1 shows a known drive arrangement with which a conventional soft stop in the crawling mode is made possible.

FIG. 2 shows, in a diagram, a drive distribution of the known drive arrangement from FIG. 1.

FIG. 3 shows a drive arrangement according to an exemplary embodiment of the invention.

FIG. 4 shows, in several diagrams, various drive distributions of the exemplary drive arrangement from FIG. 3.

### DETAILED DESCRIPTION OF THE DRAWINGS

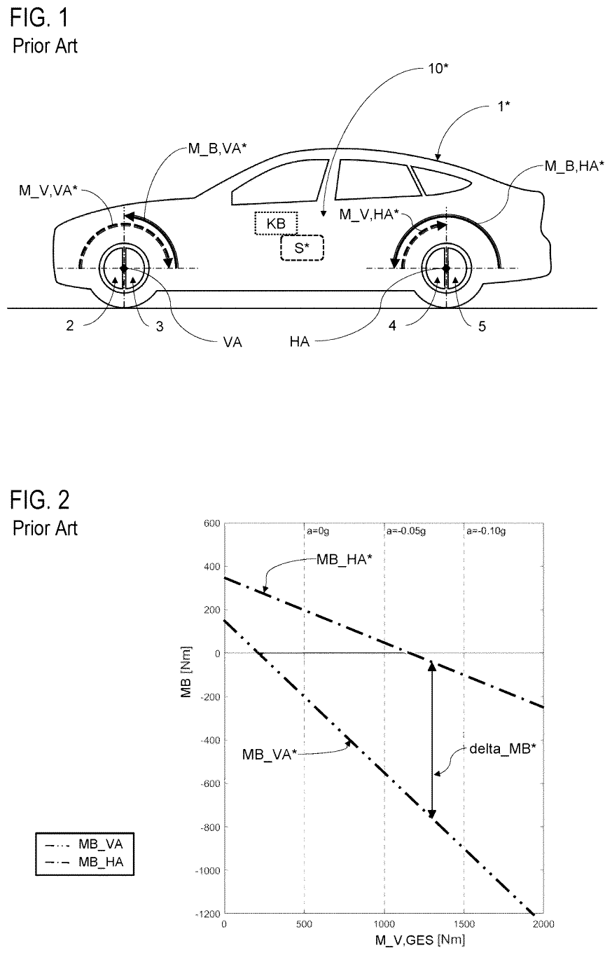

FIG. 1 shows a known drive arrangement 10* of a motor vehicle 1* with a first driven axle VA (here, the front axle), to which a first electric prime mover 2 and a first vehicle brake 3 have been assigned, and with a second driven axle HA (here, the rear axle), to which a second electric prime mover 4 and a second vehicle brake 5 have been assigned. Furthermore, the known drive arrangement 10* features a control unit S*, by means of which a conventional decelerating of the motor vehicle in a crawling mode can be triggered.

In the case of conventional decelerating, a greater part of an overall deceleration torque of the motor vehicle 1* is applied as front-axle deceleration torque M_V,VA* to the front axle VA, whereas the distinctly smaller part is applied as rear-axle deceleration torque M_V,HA* to the rear axle HA.

The situation is reversed in the case of conventional decelerating in the crawling mode with the applied acceleration torques: a greater part of an overall acceleration torque of the motor vehicle 1* is applied as rear-axle acceleration torque M_B,HA* to the rear axle HA, whereas the distinctly smaller part is applied as front-axle acceleration torque M_B,VA* to the front axle VA.

This division—which is expedient within higher speed-ranges than in a crawling mode, on account of the dynamic load distribution toward the front when braking—does not, however, offer any advantage when decelerating in the crawling mode or when stopping from the crawling mode, because only much smaller dynamic forces are acting.

But there is one disadvantage: an elastic bracing of the two axles against one another. By virtue of the distribution of force, manifested in opposing manner, of drive and brake on the axles (more braking force at the front than at the rear; more propulsive force at the rear than at the front), the chassis and the body are integrated into the bracing as a force path. As a rule, the surplus of braking force for stopping arises on the front axle at first and on the rear axle shortly after. This results in an undesirable jolt when attempting to stop comfortably.

The diagram of FIG. 2 shows, for each of the two axles VA and HA, a relationship between an overall deceleration torque M_V,GES of the motor vehicle 1 and an axle-torque balance MB of a vehicle axle. This relationship has been represented for the conventional deceleration in a characteristic MB_VA* for the front axle and in a characteristic MB_HA* for the rear axle.

The steeper characteristic MB_VA* for the axle-torque balance on the front axle reflects the overemphasis on the front axle when applying the deceleration torques in the case of a conventional deceleration. The flatter characteristic MB_HA* for the axle-torque balance on the rear axle reflects the underemphasis on the rear axle when applying the deceleration torques in the case of a conventional deceleration. The shifting of characteristic MB_VA* in the direction of decelerating reflects the underemphasis on the front axle when applying the acceleration torques in the case of a conventional drive-torque distribution. The shifting of characteristic MB_HA* in the direction of accelerating reflects the overemphasis on the rear axle when applying the acceleration torques in the case of a conventional drive-torque distribution. By virtue of the differing gradients and the respective shift, a difference in the axle-torque-balance discrepancy delta_MB* of the axle-torque balances MB_VA* and MB_HA* arises that is the greater, the more intensely the vehicle is decelerated.

If the vehicle is brought to a standstill in the state of bracing that results from the axle-torque-balance discrepancy delta MB*, this leads to an undesirable jolt which may conflict with the objective of stopping comfortably.

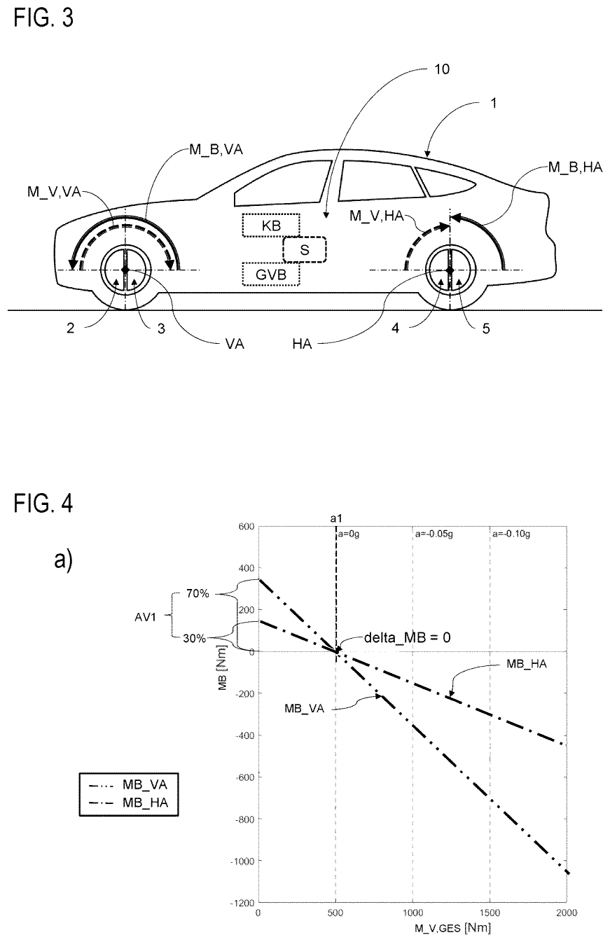

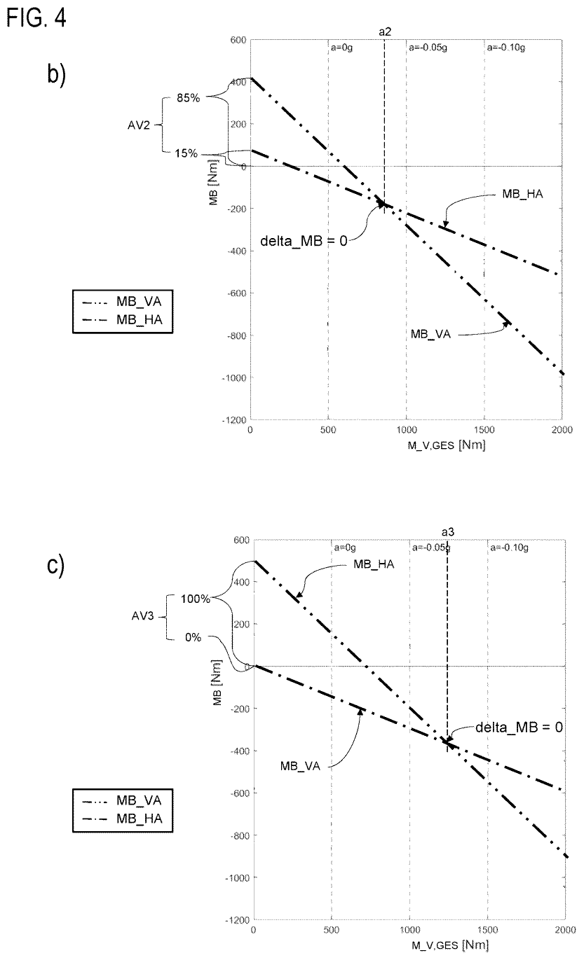

This jolt can be avoided with the exemplary embodiment of the invention that is elucidated below with reference to FIGS. 3 and 4.

FIG. 3 shows a drive arrangement 10 of a motor vehicle 1 according to an exemplary embodiment of the invention.

The drive arrangement 10 features a first driven axle VA (here, the front axle), to which a first electric prime mover 2 and a first vehicle brake 3 have been assigned. Furthermore, the drive arrangement 10 features a second driven axle HA (here, the rear axle), to which a second electric prime mover 4 and a second vehicle brake 5 have been assigned. Furthermore, the exemplary drive arrangement 10 features a control unit S which has been configured to trigger an exemplary method for operating the motor vehicle 1, especially a method for decelerating the motor vehicle, where appropriate to a standstill.

In the course of the exemplary method the following steps are carried out:
(1) identifying a desire for deceleration in respect of the motor vehicle;
(2) detecting a crawling mode KB of the motor vehicle—that is to say, in this case the crawling mode is switched, because appropriate operating conditions obtain and have been detected;
(3) triggering a predetermined drive distribution AV to the two axles, the first prime mover 2 and the second prime mover 4 being operated with identical axle-torque balances MB_VA on the front axle and MB_HA on the rear axle in the case of the triggered drive distribution AV, the axle-torque balance resulting from the offsetting of acceleration torques M_B,VA, M_B,HA, respectively, and deceleration torques M_V,VA, M_V,HA, respectively.
(4) in case the desire for deceleration is manifested as a desire to stop: triggering the drive distribution AV until the vehicle has come to a standstill.

This assimilation of the axle-torque balances MB_VA and MB_HA to identical values of the axle-torque balances on the two axles VA and HA is achieved by an optimized drive distribution AV in the crawling mode. Therefore the bracing of the chassis occurs only locally on the axles and no longer over the entire chassis and the body.

If, according to the desire for deceleration, differing absolute deceleration values are necessary until the deceleration objective (target speed and/or standstill) is attained, an adaptation of the drive distribution AV has been provided in this case in such a manner that the drive distribution is always triggered that makes possible the deceleration presently required with identical axle-torque balances MB_VA and MB_HA on both axles VA and HA.

The differences arising from this in relation to the conventional deceleration as regards the torque balances MB for various speed-changes a have been represented for various drive distributions AV1, AV2 and AV3 in the three diagrams of FIGS. 4a, 4b and 4c, each of which represents the same range of values as the diagram of FIG. 2.

By virtue of an optimized drive distribution AV in the crawling mode, an assimilation of the opposing torques on the two axles VA and HA is achieved. The two characteristics MB_VA and MB_HA may have the same gradients as in the case of conventional decelerating (in other words, as in FIG. 2), but they intersect by virtue of the approximation of the two characteristics in the case of an identical torque balance MB_VA=MB_HA, or MB_VA=MB_HA.

In FIG. 4a, a first limiting case of drive distribution AV1 is represented, which is determined by a minimally possible deceleration a (approximated to 0 g). Logically, on account of the zero acceleration a1=0 g the same torque balance MB_VA=MB_HA results correspondingly in a zero torque of MB=0 Nm on both axles VA and HA. The axle-torque-balance discrepancy delta_MB of the two axles relative to one another amounts to 0 Nm; as a result, the same torque is applied to both axles. This first limiting case in the exemplary embodiment arises in the case of a drive distribution AV1 of 70% on the front axle VA and 30% on the rear axle HA, in the case of which bracing-free operation and therefore jolt-free (or at least sufficiently low-jolt) stopping is possible for an infinitesimally small deceleration a.

In FIG. 4c, a second limiting case of drive distribution AV3 is represented, which is determined by a maximally possible spreading of drive distribution AV3 (toward the front axle) of 100% on the front axle VA and 0% on the rear axle HA. In the exemplary embodiment, this limiting case also determines the maximum deceleration a3 up to which the invention is applicable here. A greater spreading of the drive distribution is not possible, on account of which stopping without bracing between the axles is not possible in the case of greater decelerations. Here too, the axle-torque-balance discrepancy delta_MB of the two axles relative to one another also amounts to 0 Nm; as a result, the same torque is applied to both axles.

In FIG. 4b, a drive distribution AV2 that makes possible a bracing-free decelerating in the case of deceleration a2 is represented by way of example of all absolute deceleration values between a1=0 g and a3. Here too, the axle-torque-balance discrepancy delta_MB of the two axles relative to one another also amounts to 0 Nm; as a result, the same torque is applied to both axles. This exemplary case in the exemplary embodiment arises in the case of a drive distribution AV1 of 85% on the front axle VA and 15% on the rear axle HA.

Between the two extreme values of decelerations a1 and a3, a drive distribution AV, in the case of which the longitudinal deceleration a of the vehicle occurs without a bracing of the two axles against one another, can consequently be triggered for each deceleration a. With such a triggering, the deceleration manages without an undesirably big jolt when stopping. To do this, an adaptation of the drive distribution AV has been provided in such a manner that for the purpose of putting the desire for deceleration into effect the drive distribution AV is always triggered that makes possible the deceleration presently required with identical axle-torque balances MB_VA and MB_HA on both axles VA and HA.

### LIST OF REFERENCE SYMBOLS

motor vehicle 1
first electric prime mover 2
first vehicle brake 3
second electric prime mover 4
second vehicle brake 5
drive arrangement 10
(absolute) deceleration a
axle-torque-balance discrepancy delta_MB
first driven axle (front axle) VA
second driven axle (rear axle) HA
control unit S
crawling mode KB
axle-torque balance MB
characteristic, front axle MB_VA
characteristic, rear axle MB_HA
front-axle acceleration torque M_B,VA
front-axle deceleration torque M_V,VA
rear-axle acceleration torque M_B,HA
rear-axle deceleration torque M_V,HA
overall deceleration torque M_V,GES

1-12. (canceled)

13. A method for operating a motor vehicle in a crawling mode, the motor vehicle comprising a first driven axle, to which a first electric prime mover has been assigned, and with a second driven axle, to which a second electric prime mover has been assigned, the method comprising:
identifying an indication to decelerate the motor vehicle,
triggering a predetermined drive distribution to the first driven axle and the second driven axle, where the first prime mover and the second prime mover are operated with identical axle-torque balances in the triggered drive distribution.

14. The method according to claim 13, wherein:
the drive distribution provides a greater part of a drive torque applied to both axles overall on a front axle.

15. The method according to claim 13, wherein:
the drive distribution is a function of an absolute deceleration that is required for the purpose of putting the identified indication of decelerate the motor vehicle into effect.

16. The method according to claim 13, wherein:
differing drive distributions are predetermined for differing required absolute decelerations.

17. The method according to claim 13, wherein:
differing axle-torque balances, which are identical on both axles, are triggered for differing required absolute decelerations.

18. The method according to claim 13, wherein:
a maximally achievable deceleration is determined by a drive distribution that is wholly to the first electric prime mover.

19. The method according to claim 13, further comprising:
identifying an indication to stop the motor vehicle; and
in response to identifying the indication to stop the motor vehicle, triggering the predetermined drive distribution at least until the motor vehicle comes to a standstill.

20. The method according to claim 13, wherein:
in the course of putting an identified desire to stop into effect outside of a crawling mode, firstly a classical deceleration mode with a higher deceleration torque on the front axle and with a higher acceleration torque on the rear axle is triggered, and
the predetermined drive distribution is triggered in the course of the crawling mode or after entering it.

21. The method according to claim 13, wherein:
after a standstill, a requisite standstill deceleration torque is applied equally by both prime movers.

22. The method according to claim 13, wherein:
front-axle deceleration torques are applied by at least one of means of a first vehicle brake or means of the first prime mover.

23. The method according to claim 13, wherein:
rear-axle deceleration torques are applied by at least one of means of a second vehicle brake or means of the second prime mover.

24. A drive arrangement of a motor vehicle with a first driven axle, to which a first electric prime mover has been assigned, and with a second driven axle, to which a second electric prime mover has been assigned, and with a control unit which has been configured to trigger the method of claim 13.
